(19) United States
(12) Patent Application Publication
(10) Pub. No.: US 2018/0043422 A1
(43) Pub. Date: Feb. 15, 2018

(54) FRAME ASSEMBLY AND METHOD FOR MOUNTING A REAR MAIN SEAL TO A CRANKSHAFT OF A PORSCHE

(71) Applicant: Luis Eusebio GONZALEZ-LAUZAN, Miami, FL (US)

(72) Inventor: Luis Eusebio GONZALEZ-LAUZAN, Miami, FL (US)

(21) Appl. No.: 15/234,678

(22) Filed: Aug. 11, 2016

(51) Int. Cl. B21K 1/08; F16J 15/3268

(52) U.S. Cl. CPC B21K 1/08; F16J 15/3268; F16C 3/14

(57) ABSTRACT

A frame assembly and method for mounting a rear main crankshaft seal to a rear region of a crankshaft for a Porsche™. The assembly provides an annular cylinder that firmly encircles a Porsche™ rear main crankshaft seal. The cylinder and the retained seal are configured to press into a crankshaft groove that forms at the rear region of the crankshaft. The cylinder maintains the seal in an annular shape, even after a long duration of use. The cylinder comprises a lubricant that coats the seal. Two brackets fasten the cylinder and the retained seal in a crankshaft groove at the crankshaft. The assembly is specifically designed for: a Porsche Boxter 996™ made in the years of 1997-2010 or a Porsche Carrera 911™ made in the years 2005-2010.

### BACKGROUND

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon.

The present invention is directed to frame assembly and method for mounting a rear main crankshaft seal to a rear region of a crankshaft for a Porsche™.

The inventor is a Porsche™ enthusiast that enjoyed both driving and working on Porsches, and specifically the Porsche Boxter 996™ made in the years of 1997-2010 and the Porsche Carrera 911™ made in the years 2005-2010.

The inventor was aware that one of the most problematic aspects of the Porsche™ was the rear main crankshaft seal. This seal is used to prevent oil from leaking at the rear region of the crankshaft. The inventor knew that, in the case of a smaller, high viscosity vehicle with a manual transmission, such as the Porsche™, a faulty or worn rear main crankshaft seal can allow oil to leak onto the clutch, causing slipping and chattering.

Through experimentation, the inventor understood that the rear main crankshafts seal offers proven sealing ability, excellent heat resistance and easy installation. The seals were fabricated primarily from molded synthetic rubber.

Unfortunately, the inventor knew that after a duration of 70,000 miles, heat and pressure work to deform, oxidizes, or completely deteriorate this rubber material. This was especially problematic in a high performance sports vehicle, such as a Porsche™. Thus, the inventor attempted to invent a frame assembly that is effective for maintaining the annular shape of the seal, and lubricating the seal.

The inventor recognized a problem in that the elastomer properties of the seal were susceptible to high temperatures. The inventor decided to encase the seal in a metal cylinder.

Through additional research, the inventor learned that the seal rested in a groove at the rear region of the crankshaft, generally around a pilot shaft bearing. The inventor decided to add a flange to one end of the cylinder that would catch onto the edge of the groove, so as to create a more secure housing of the cylinder.

However, the cylinder and the seal contained within vibrated excessively. So the inventor decided to add two brackets that would fasten the edges of the cylinder to the crankshaft. The brackets were disposed opposite of each other and screwed into mounting holes in the crankshaft.

The inventor realized that the life expectancy of the seal was short, even with the protective metal cylinder. The inventor decide to coat the inner surface of the cylinder with a lubricant that would transfer to the seal. This would protect against heat hardening and oxidation of the elastomer material of the seal

For the foregoing reasons, there is a frame assembly and method for mounting a rear main crankshaft seal to a rear region of a crankshaft for a Porsche™. The assembly provides an annular cylinder that firmly encircles a Porsche™ rear main crankshaft seal. The cylinder and the retained seal are configured to press into a crankshaft groove that forms at the rear region of the crankshaft. The cylinder maintains the seal in an annular shape, even after a long duration of use. The cylinder comprises a lubricant that coats the seal. Two brackets fasten the cylinder and the retained seal in a crankshaft groove at the crankshaft.

Oil seal and gasket fitting system and methods have been utilized in the past; yet none with the characteristics of the present invention. See U.S. Pat. Nos. 3,755,875, 5,588,656; and 6,543,113.

For the foregoing reasons, there is a frame assembly and method for mounting a Porsche™ rear main crankshaft seal to a rear region of a crankshaft for a Porsche™.

### SUMMARY

The present invention describes a frame assembly and method for mounting a rear main crankshaft seal to a crankshaft of a Porsche™. The frame assembly provides a rigid, annular cylinder that firmly encircles a rear main crankshaft seal. The cylinder and the retained seal are configured to press into a crankshaft groove that forms at the rear region of the crankshaft. In this manner, the seal the assembly forms a protective frame around the seal that extends the life of the seal.

The frame assembly provides at least one bracket that mounts the cylinder and the retained seal in a crankshaft groove that forms at a rear region of a crankshaft. The annular shape of the cylinder prevents deformation of the seal, even after an extended duration of use. The cylinder may also be coated with a lubricant to help prevent heat hardening and oxidation of the substantially elastomeric seal.

In one embodiment, a frame assembly for mounting a Porsche rear main crankshaft seal comprises a generally annular cylinder. The cylinder is defined by a first end and a second end. The second end comprises a flange. The cylinder is further defined by an outer surface having an outer diameter, and an inner surface having an inner diameter. The inner diameter is generally smaller than the outer diameter. The inner surface of the cylinder is configured to engage the rear main crankshaft seal, whereby the seal is disposed proximal to the first end of the cylinder. A snug fit between the inner surface of the cylinder and the seal helps retain the seal in the cylinder, and in conformance with the annular shape of the cylinder.

In some embodiments, the assembly further comprises at least one bracket configured to enable mounting of the cylinder and the retained seal to a rear region of a crankshaft for a Porsche™. The at least one bracket is defined by a first panel and a second panel disposed perpendicularly to each other. The first panel joins with the flange of the second end of the cylinder. The second panel may include an aperture. At least one fastener is configured to pass through the aperture of the second panel to fasten the cylinder and the retained seal in the rear region of the crankshaft.

In another aspect, the inner diameter of the cylinder is about 90 millimeters.

In another aspect, the outer diameter of the cylinder is about 110 millimeters.

In another aspect, the first panel of the at least one bracket has a generally L-shape.

In another aspect, the at least one bracket comprises two brackets.

In another aspect, the at least one fastener comprises two fasteners.

In another aspect, the at least one fastener comprises a threaded bolt.

In another aspect, the at least one fastener is configured to fasten the at least one bracket and the cylinder to a rear region of a crankshaft.

In another aspect, the assembly is configured to enable mounting of a rear main crankshaft seal for a Porsche™.

In another aspect, the cylinder is shaped and sized to snugly fit inside a crankshaft groove in a rear region of a crankshaft for the Porsche™.

In another aspect, the inner surface of the cylinder is configured to engage the rear main crankshaft seal, whereby the rear main crankshaft seal is disposed proximal to the first end of the cylinder.

In another aspect, the inner surface of the cylinder comprises a lubricant.

In another aspect, the cylinder is configured to mount the rear main crankshaft seal in a crankshaft groove.

In another aspect, the Porsche™ includes at least one member selected from the group consisting of: a Porsche Boxter 996™ made in the years of 1997-2010 or a Porsche Carrera 91™ made in the years 2005-2010.

In another aspect, the material of the rear main crankshaft seal includes at least one member selected from the group consisting of: polyacrylate, nitrile rubber, silicone, polytetrafluoethylene rubber, and molded synthetic rubber.

In another aspect, the assembly is an aftermarket component.

In one aspect, a method for mounting a rear main crankshaft seal to a rear region of a crankshaft for a Porsche™, comprises:
removing a flywheel from a rear region of a crankshaft;
disengaging an expired rear main crankshaft seal from a crankshaft groove;
providing a frame assembly having a generally annular cylinder and at least one bracket;
lubricating an inner surface of the cylinder;
positioning a new rear main crankshaft seal in the inner surface of the cylinder,
whereby the new rear main crankshaft seal substantially maintains the annular shape of the cylinder;
mounting the cylinder and the retained new rear main crankshaft seal in the crankshaft groove; and
fastening the at least one bracket to the rear region of the crankshaft.

One objective of the present invention is to mount a rear main crankshaft seal in a rear region of a Porsche™ crankshaft; and especially when the seal expires after 70,000 miles.

Another objective of the present invention is to prevent the seal from deforming to an oval shape by retaining the seal in the annular shape of the cylinder.

Another objective of the present invention is to lubricate the seal.

Yet another objective of the present invention is to provide at least one bracket for securely fastening the cylinder and the seal that is retained in the cylinder to the rear region of the crankshaft.

Yet another objective is to provide an inexpensive assembly for replacing and mounting a seal in the rear region of the crankshaft of the Porsche Boxter 996™ made in the years of 1997-2010 and the Porsche Carrera 911™ made in the years 2005-2010.

### DRAWINGS

These and other features, aspects, and advantages of the present invention will become better understood with regard to the following description, appended claims, and drawings where:

FIG. 1 is a perspective view of an exemplary frame assembly for mounting a rear main crankshaft seal to a rear region of a crankshaft for a Porsche™;

FIG. 2 is a sectioned view of an exemplary frame assembly for mounting a rear main crankshaft seal to a rear region of a crankshaft for a Porsche™;

FIG. 3 is a perspective view of the frame assembly shown in FIG. 1 being positioned proximally to a crankshaft groove for mounting;

FIG. 4 is a sectioned view of the frame assembly shown in FIG. 1 mounted into the crankshaft groove at the rear region of the crankshaft;

FIG. 5 is a perspective view of the frame assembly shown in FIG. 1 mounted into the crankshaft groove at the rear region of the crankshaft; and

FIG. 6 is a flowchart diagram of an exemplary method for mounting a rear main crankshaft seal to a rear region of a crankshaft for a Porsche™.

### DETAILED DESCRIPTION

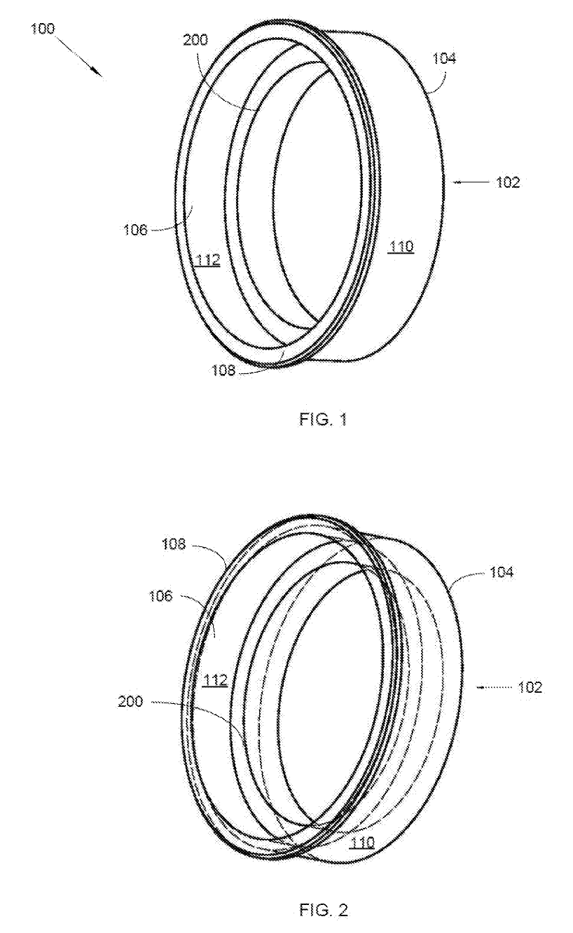

The present invention, referenced in FIGS. 1-6, is directed to a frame assembly 100 and method 200 for mounting a rear main crankshaft seal 200 to a crankshaft 202 of a Porsche™. As FIG. 1 references, the assembly 100 and method 200 provide an annular cylinder 102 that snugly encircles and at least partially encases a rear main crankshaft seal 200 used in a Porsche™. The cylinder 102 and the retained seal 200 are configured to press into a crankshaft groove 204 that forms at the rear region of the crankshaft 202. At least one bracket 114a, 114b fastens the cylinder 102 and the retained seal 200 to the rear region of the crankshaft 202. In this manner, the assembly 100 forms a protective frame around the seal 200 that extends the life of the seal 200.

The frame assembly 100 is designed for a specific few types of Porsches™, including: the Porsche Boxter 996™ made in the years of 1997-2010 and the Porsche Carrera 911™ made in the years 2005-2010.

The frame assembly 100 and method 200 provide numerous advantageous to replacing and mounting the rear main crankshaft seal 200 in the Porsche™ crankshaft. Firstly, the seal 200 is forced to conform to the annular shape of the cylinder 102, which prevents the seal 200 from deforming to an oval shape, even after the seal 200 has been used for over 70,000 miles. FIG. 2 shows the seal 200 conforming to the shape of the cylinder 102. Yet another advantage provided by the frame assembly 100 and method 200 is that an inner surface 112 of the cylinder 102 may contain, or be coated with a layer of a lubricant that transfers to the seal 200. The lubricant helps prevent heat hardening and oxidation of the substantially elastomeric seal 200.

Those skilled in the art will recognize that rear main crankshaft seals prevent oil from leaking at the rear region of the crankshaft. In the case of a smaller, high viscosity vehicle with a manual transmission, i.e., Porsche™, a faulty or worn rear main crankshaft seal can allow oil to leak onto the clutch, causing slipping and chattering. The rear main crankshafts seals offers proven sealing ability, excellent heat resistance and easy installation. Molded synthetic rubber is the material most commonly used for the rear main crankshaft seal. However, after a duration of 70,000 miles, heat and pressure work to deform, oxidizes, or completely deteriorate this rubber material. This can be especially problematic in a high performance sports vehicle, such as a Porsche™. Thus, the frame assembly 100 is effective for maintaining the annular shape of the seal 200, and lubricating the seal 200 while the seal 200 is snugly retained within the inner surface 112 of the cylinder 102.

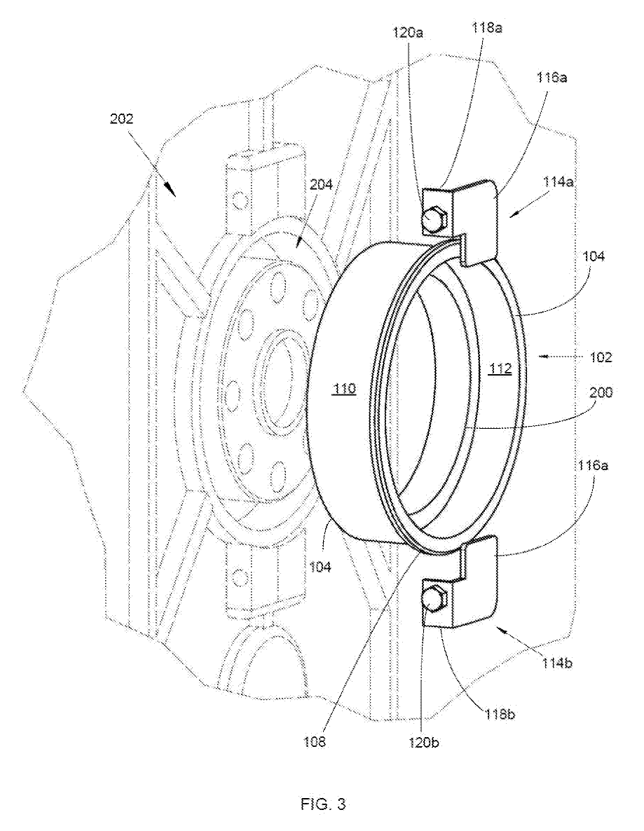

Looking now at FIG. 3, the frame assembly 100 comprises a generally annular cylinder 102 that is shaped and sized to snugly fit inside a crankshaft groove 204 in a rear region of a crankshaft for a Porsche™. The cylinder 102 has a depth of a few inches and an outer surface 110 that snugly engages an inner perimeter area of the crankshaft groove 204. In some embodiments, the cylinder 102 may be fabricated substantially from a metal alloy that can withstand high temperatures, which are experienced in crankshafts, and provide protection for the seal 200.

Looking back at FIG. 1, the cylinder 102 is defined by a first end 104 and a second end 106. The ends 104, 106 form the opposite edges of the cylinder 102. The first end 104 terminates at a generally flat edge. The second end 106 terminates at a flange 108 that extends outwardly, towards the outer surface 110 of the cylinder 102. When the cylinder 102 is positioned in the crankshaft groove 204 at the rear region of the crankshaft 202, the flange 108 engages the perimeter area of the crankshaft groove 204.

The cylinder 102 is further defined by an outer surface 110 having an outer diameter, and an inner surface 112 having an inner diameter. The inner surface 112 of the cylinder 102 is configured to engage the rear main crankshaft seal 200. In one embodiment, the seal 200 is positioned more proximally to the first end 104 of the cylinder 102 than the second end 106. A snug fit between the inner surface 112 of the cylinder 102 and the seal 200 helps retain the seal 200 in the cylinder 102, and in conformance with the annular shape of the cylinder 102.

The inner diameter of the cylinder 102 is generally smaller than the outer diameter. In one embodiment, the inner diameter of the cylinder 102 is about 90 millimeters. The outer diameter of the cylinder 102 is about 110 millimeters. In one embodiment, the inner surface 112 comprises a lubricant. When the seal 200 is pressed into the inner surface 112, the lubricant coats the seal 200 to protect the elastomer material against heat hardening and oxidation.

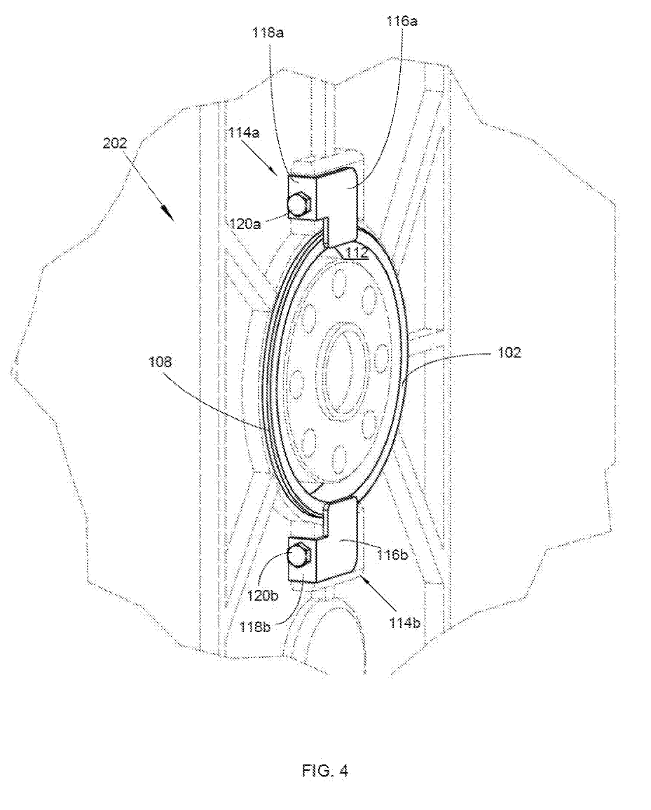

As FIG. 4 illustrates, the assembly 100 further comprises at least one bracket 114a, 114b configured to enable mounting of the cylinder 102 and the retained seal 200 to a rear region of a crankshaft for the Porsche™. The rear region 202 where the seal 200 mounts is generally around the pilot shaft bearing of the crankshaft. In one embodiment, two bracket 114a, 114bs are used for mounting the cylinder 102 to the crankshaft.

The at least one bracket 114a, 114b is defined by a first panel 116a, 116b and a second panel 118a, 118b disposed perpendicularly to each other. The first panel 116a, 116b has a generally L-shape. The first panel 116a, 116b joins with the flange 108 of the second end 106 of the cylinder 102. In one embodiment, the first panel 116a, 116b and the flange 108 are fixedly joined. In other embodiments, the first panel 116a, 116b and the flange 108 are detachably attached, through screws, magnets, or welds.

The second panel 118a, 118b may include an aperture. At least one fastener 120a, 120b is configured to pass through the aperture of the second panel 118a, 118b to fasten the cylinder 102 and the retained seal 200 in the rear region of the crankshaft 202. In one embodiment, the brackets 114a, 114b are disposed at opposite areas of the cylinder 102 and screwed directly into mounting holes in the crankshaft.

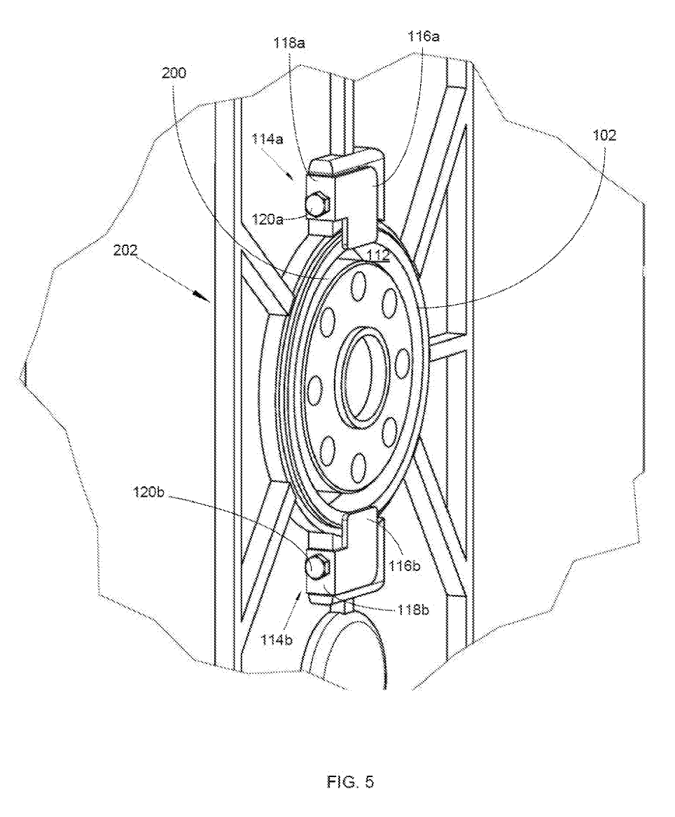

FIG. 5 illustrates the cylinder 102 and the retained seal 200 fastened to the rear region of the crankshaft 202. The first end 104 of the cylinder 102 engages the back of the crankshaft groove 204. The second end 106 of the cylinder 102 terminates at the flange 108, which overhangs the perimeter area of the crankshaft groove 204.

In one embodiment, the at least one fastener 120a, 120b comprises two fasteners 120a, 120b configured to pass through each aperture in two brackets 114a, 114b. The fastener 120a, 120b may include, without limitation, a screw, a threaded bolt, a weld, a magnet, and a wire.

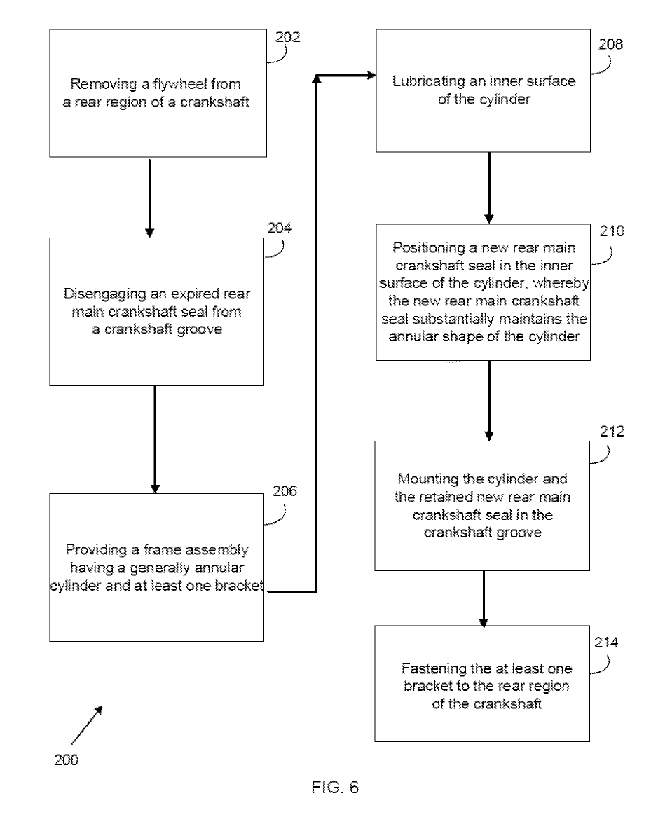

FIG. 6 illustrates a flowchart diagram of an exemplary method 200 for mounting a rear main crankshaft seal to a crankshaft of a Porsche™. The method 200 may include an initial Step 202 of removing a flywheel from a rear region of a crankshaft 202. The rear main crankshaft seal 200 is located behind the flywheel, which requires the flywheel to be removed to change the seal 200. Generally, a flywheel lock is used to remove bolts that hold down the flywheel.

The method 200 may further comprise a Step 204 of disengaging an expired rear main crankshaft seal from a crankshaft groove 204. A Step 206 includes providing a frame assembly 100 having a generally annular cylinder 102 and at least one bracket 114a, 114b. The frame assembly 100 mounts a rear main crankshaft seal 200 to a rear region of a crankshaft 202 for a Porsche™.

In some embodiments, a Step 208 comprises lubricating an inner surface 112 of the cylinder 102. The lubricant may include an oil or other synthetic lubricant that extends the life of the seal 202. A Step 210 includes positioning a new rear main crankshaft seal 200 in the inner surface 112 of the cylinder 102, whereby the new rear main crankshaft seal 200 substantially maintains the annular shape of the cylinder 102. A snug fit between the inner surface 112 of the cylinder 102 and the new seal helps retain the new seal in the cylinder 102, and in conformance with the annular shape of the cylinder 102.

In some embodiments, a Step 212 may include mounting the cylinder 102 and the retained new rear main crankshaft seal 200 in the crankshaft groove 204. The second end 106 terminates at a flange 108 that extends outwardly, towards the outer surface 110 of the cylinder 102. When the cylinder 102 is positioned in the crankshaft groove 204 at the rear region of the crankshaft 202, the flange 108 engages the perimeter area of the crankshaft groove 204.

A final Step 214 includes fastening the at least one bracket 114a, 114b to the rear region of the crankshaft. The bracket 114a, 114b enables mounting of the cylinder 102 and the retained seal 200 to a rear region of a crankshaft 202 for the Porsche™. The rear region 202 where the seal 200 mounts generally surrounds the pilot shaft bearing of the crankshaft. The brackets 114a, 114b are disposed at opposite areas of the cylinder 102 and screwed directly into mounting holes in the crankshaft.

While the inventor's above description contains many specificities, these should not be construed as limitations on the scope, but rather as an exemplification of several preferred embodiments thereof. Many other variations are possible. For example, the frame assembly 100 may be adapted for securing main crankshaft seals for different models of vehicles. Accordingly, the scope should be determined not by the embodiments illustrated, but by the appended claims and their legal equivalents.

What is claimed is:

1. A frame assembly for mounting a rear main crankshaft seal to a crankshaft of a Porsche™, the assembly comprising:
a generally annular cylinder defined by a first end and a second end having a flange, the cylinder further defined by an outer surface having an outer diameter and an inner surface having an inner diameter;
at least one bracket configured to enable mounting of the cylinder, the at least one bracket defined by a first panel and a second panel, the first panel configured to join with the flange of the second end of the cylinder, the first panel disposed generally perpendicular to the second panel, the second panel having an aperture; and
at least one fastener configured to pass through the aperture of the second panel.

2. The assembly of claim 1, wherein the inner diameter of the cylinder is about 90 millimeters.

3. The assembly of claim 1, wherein the outer diameter of the cylinder is about 110 millimeters.

4. The assembly of claim 1, wherein the first panel of the at least one bracket has a generally L-shape.

5. The assembly of claim 1, wherein the at least one bracket comprises two brackets.

6. The assembly of claim 1, wherein the at least one fastener comprises two fasteners.

7. The assembly of claim 1, wherein the at least one fastener comprises a threaded bolt.

8. The assembly of claim 1, wherein the at least one fastener is configured to enable fastening the at least one bracket and the cylinder to a rear region of the crankshaft.

9. The assembly of claim 1, wherein the assembly is configured to enable mounting of the rear main crankshaft seal for the Porsche™.

10. The assembly of claim 1, wherein the cylinder is shaped and sized to snugly fit inside a crankshaft groove in a rear region of a crankshaft for the Porsche™.

11. The assembly of claim 1, wherein the inner surface of the cylinder is configured to enable engagement to the rear main crankshaft seal, whereby the rear main crankshaft seal is disposed proximal to the first end of the cylinder.

12. The assembly of claim 1, wherein the inner surface of the cylinder comprises a lubricant.

13. The assembly of claim 1, wherein the cylinder is configured to mount the rear main crankshaft seal in a crankshaft groove.

14. The assembly of claim 1, wherein the material of the rear main crankshaft seal includes at least one member selected from the group consisting of: polyacrylate, nitrile rubber, silicone, polytetrafluoethylene rubber, and molded synthetic rubber.

15. The assembly of claim 1, wherein the Porsche™ includes at least one member selected from the group consisting of: the Porsche Boxter 996™ made in the years of 1997-2010 and the Porsche Carrera 911™ made in the years 2005-2010.

16. A frame assembly for mounting a rear main crankshaft seal to a crankshaft of a Porsche™, the assembly comprising:
a generally annular cylinder defined by a first end and a second end having a flange, the cylinder further defined by an outer surface having an outer diameter and an inner surface having an inner diameter, the outer diameter being about 110 millimeters, the inner diameter being about 90 millimeters;
two brackets configured to enable mounting of the cylinder, the two brackets defined by a first panel and a second panel, the first panel configured to join with the flange of the second end of the cylinder, the first panel disposed generally perpendicular to the second panel, the second panel having an aperture; and
at least one fastener configured to pass through the aperture of the second panel.

17. A method for mounting a rear main crankshaft seal to a crankshaft of a Porsche™, the method comprising:
removing a flywheel from a rear region of a crankshaft;
disengaging an expired rear main crankshaft seal from a crankshaft groove;
providing a frame assembly having a generally annular cylinder and at least one bracket;
lubricating an inner surface of the cylinder;
positioning a new rear main crankshaft seal in the inner surface of the cylinder, whereby the new rear main crankshaft seal substantially maintains the annular shape of the cylinder;
mounting the cylinder and the retained new rear main crankshaft seal in the crankshaft groove; and
fastening the at least one bracket to the rear region of the crankshaft.

18. The method of claim 17, wherein the at least one bracket comprises two brackets.
